(19) United States
(12) Patent Application Publication
(10) Pub. No.: US 2006/0073845 A1
(43) Pub. Date: Apr. 6, 2006

(54) Wireless apparatus for identification and multimedia files transmission

(76) Inventor: Hui Lin, Taipei (TW)

Correspondence Address: PRO-TECTOR INTERNATIONAL SERVICES, 20775 NORADA CT., SARATOGA, CA, 95070, US

(21) Appl. No.: 11/188,454

(22) Filed: Jul. 25, 2005

(30) Foreign Application Priority Data
Aug. 3, 2004 (TW) 093123259

(51) Int. Cl. H04M 1/00

(52) U.S. Cl. 455/550.1

(57) ABSTRACT

The present invention relates to a wireless apparatus for identification and multimedia files transmission. To utilize on audio-visual devices, this wireless apparatus integrates an IC card copy protection, a RF (Radio Frequency) wireless communication, and an addressing and communication technologies of communication interface, like USB (Universal Serial Bus) for example, into a designed SOC (System on Chip) to control. In combination with several identification hardware and software, the wireless apparatus installed in audio-visual devices can reduce jamming and illegal copying, and also free from the work of wires pulling.

### BACKGROUND OF THE INVENTION

1. Field of the Invention

The present invention relates to wireless apparatus for identification and multimedia files transmission, which particularly relates to an encrypted secure communication of multimedia of audio and/or video files via a wireless apparatus, to prevent leaking out and reduce distortion due to communication.

2. Description of the Related Art

Nowadays modern people are living in a music or audio world. Instead of playing audio CD (Compact Disc), since MP3 (MPEG Audio Layer 3) technique was wide known and popular, most music is played in a digital compressed file format, like WMA (Windows Media Audio), AAC (Advanced Audio Coding), or said MP3. MP3 files can be acquired from several methods: directly compressed from an audio CD, from e-mail which friends sent, or from P2P (Peer to Peer) files sharing mode on Internet. Music file in a compressed format is very small in storage, and music can be easily saved and played on demand in an exquisite player without caring many CDs.

However, the record companies wish to rule not only what we can listen, but also where we can listen, by a new Digital Rights Management (DRM) mechanism. Simplify With DRM, no matter how music is consumed, like played in streaming file, broadcasted on Internet, downloaded, or sold a CD, the whole music industry can gain a profit. For the industry, DRM makes consumers clarified: what you bought music is not belong to you, but you only buy a (very limited) listening right.

The Electronic Frontier Foundation presents a whole new music consuming mechanism. Music will be on longer made a price of each piece, but every user who utilizes download service will pay a fixed fee instead. This fee, like broadcast playing fee of radio stations, was distributed to the artists according to the counts of trades of music files on this platform. Assume that there are 60 million files exchanging users making $5 dollars payment each month, the whole music industry will gain near $3 billion dollars per year. The file format can almost suit all household electric appliances, but not be limited to what the record companies want you to buy. The consumers are freed form the made price. Mobile wireless download services will become a new growth industry. Contents services gains are profitable to the depressed 3G mobile communication network industry.

### SUMMARY OF THE INVENTION

Music files are easily obtained via web sites, e-mails, and wireless transmissions. Most files are spread with no copy protection technique treatment or a weak protection. A copy protection method utilizes an IC (Integrated Circuit) chip card, which is easily integrated into a system with a corresponding IC card reader accessing a simple APT (Application Program Interface) module of IC card, and a given identification code thereof to replace old serial number protection. Copy protection technologies mean to protect intellectual properties. As the crackers advance their ability of decipherment day by day, these copy protection techniques today are relatively getting weaker and full of leaks. More new indecipherable code or special file format techniques are needed to resist clever brains in technologies.

Besides copy protection, fine music needs fine audio system. Most multimedia systems transmit with cables or wires linkage between devices, like amps and speakers. In modern home theater systems, surrounding speakers are set on far side of amp, and wires pulling among decorations in a house will be a difficult problem. In analog audio systems wires upgrades mean lots of works. Some wireless transmission technologies are utilized in audio systems, but interference or jamming degrades the quality of sound, and meanwhile, the wireless transmission is interceptable.

For the above-mentioned problems, this present invention discloses a wireless apparatus combination of an IC card copy protection, RF (Radio Frequency) wireless communication, and addressing and communication technologies of communication interface, like USB (Universal Serial Bus), to be integrated into a single designed SOC (System on Chip) controller. With identification hardware and software, comprising password identification, fingerprint identification, and encryption identification procedures, the wireless apparatus of the present invention can reduce distortion and interference, prevent unauthorized copy, and also free from the trouble of wires pulling.

### BRIEF DESCRIPTION OF THE DRAWINGS

FIG. 1 is a diagram of the perspective view of the present invention;

FIG. 2 is a diagram of the explosive view of the present invention;

FIG. 3 is a diagram of the operation procedure of the present invention;

FIG. 4 is a diagram showing the first embodiment of the present invention;

FIG. 5 is a diagram showing the second embodiment of the present invention.

### DETAILED DESCRIPTION OF THE PREFERRED EMBODIMENTS

In the following description, please refer to the drawings.

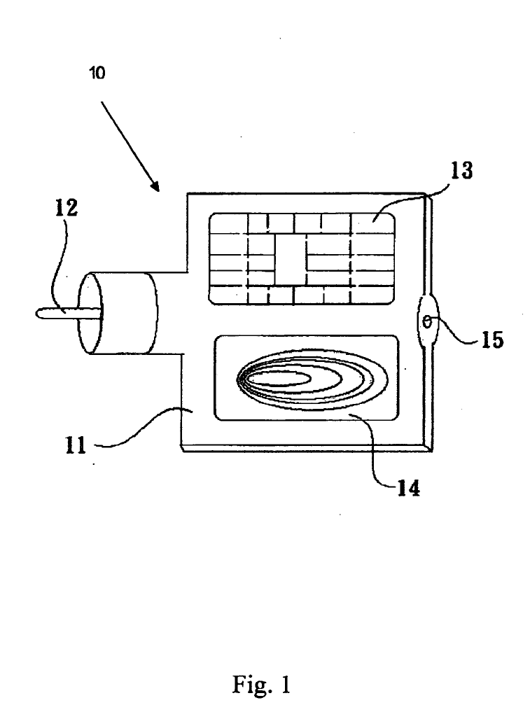

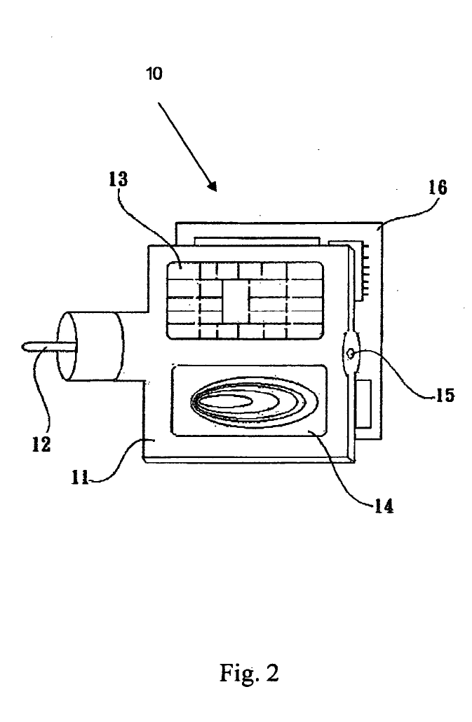

As shown in FIG. 1, the wireless apparatus 10 of the present invention comprises a connector 12, which is set on a case 11 of the wireless apparatus 10. The case 11 comprises an IC card chip 13 and a fingerprint scanner 14. The given identification code for authorized transmission is stored in the IC card chip 13 as a first hardware identification. The fingerprint scanner 14 is a second hardware identification device to identify the authorization of a scanned fingerprint. The case 11 further comprises a wireless transceiver 15 used to input/output the multimedia data. Please refer to the FIG. 2, a circuit board 16 is installed inside the case 11. Besides normal connection circuits, the circuit board 16 comprises a single designed SOC (System on Chip), which comprises a IC card copy protection, a RF (Radio Frequency) wireless communication, and an addressing and communication technologies of communication interface, like USB (Universal Serial Bus), integration. Via the SOC identification, the multimedia files will be identified before transmission, and then be compressed and encrypted to transmit to the wireless receiver side. The SOC on the receiver side will decompress the multimedia files to play.

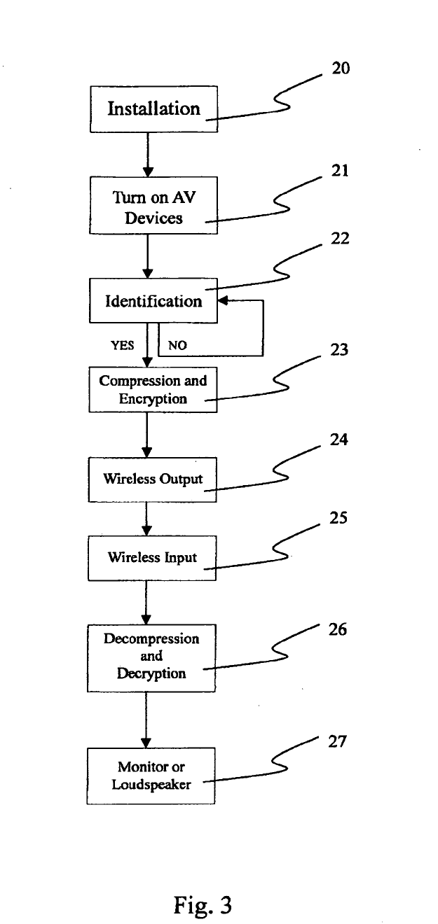

Referring to the FIG. 3 is a diagram of the operation procedure of the present invention. First step is installation of the wireless apparatus onto multimedia AV (audio-visual) devices and monitor or loudspeaker 20. Turn on multimedia AV devices 21 and the played multimedia data is identified via the identification software and hardware 22, which comprising the IC card copy protection, RF (Radio Frequency) wireless communication, addressing and communication technologies of communication interface like USB for example, fingerprint identification, and encryption identification. If the multimedia data pass identifications, data will be compressed and encrypted 23, otherwise the procedure backs to the identification step 22. The compressed and encrypted multimedia data will output via the transmitter of the wireless apparatus 24. The receiver of the wireless apparatus on the other side will input the transmitted data 25. The received multimedia data will be decompressed and decrypted 26 and then in the final step the monitor or loudspeaker reproduces an image and/or a sound 27. Without the wireless apparatus in the present invention the compressed and encrypted multimedia data are indecipherable and cannot be played.

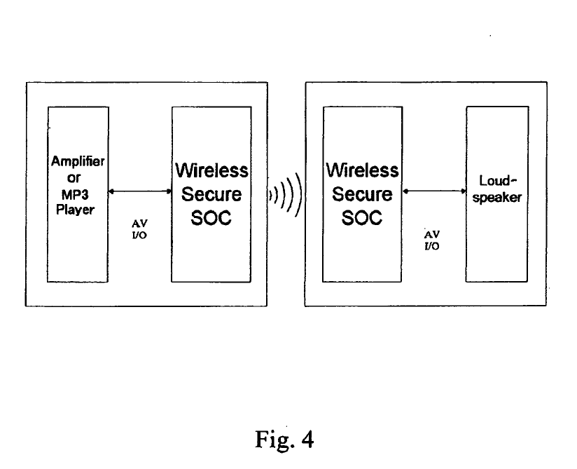

In the FIG. 4 is a diagram showing the first embodiment of the present invention. The multimedia devices like amplifier or MP3 player transmit the multimedia data to the SOC of the wireless apparatus of the present invention to apply the identifications comprising at least one of followings: IC card copy protection, a RF wireless communication, an addressing and communication technologies of communication interface, password, fingerprint, and encryption. When identifications applied the multimedia data are compressed and encrypted, and then transmitted to the wireless apparatus on receiving side installed in the following AV device. The received multimedia data will be decompressed and decrypted by the SOC of the receiving wireless apparatus then reproduced by the following AV device. In the FIG. 5 the operation module of the wireless apparatus of the embodiment of the present invention is shown.

The foregoing describing of the preferred embodiment of the invention is for the purposes of illustration and description. It is not intended to exhaustive or to limit the invention to the precise from disclosed. Many other possible modifications and variations can be made without departing from the scope of the present invention, which following claims are depended.

What is claimed is:

1. A wireless apparatus for identification and multimedia files transmission comprises:
a case;
a circuit board, which is installed inside the case, to storage and access data;
an identification hardware, which is installed on surface of the case, comprising a IC card chip;
a wireless transceiver, which is set on the side of the case, to transmit and receive data;
a connector, which is set on the side of the case, to connect to a audio-visual device;
wherein the characterized is in that the circuit board comprises a SOC (System on Chip) to control a compression, a decompression, a encryption, a decryption, a transmission, an identification, a storage, and a temporary storage unit for identification and multimedia files transmission.

2. The wireless apparatus according to claim 1, wherein the transmission unit is a RF (Radio Frequency) input/output wireless communication unit.

3. The wireless apparatus according to claim 1, wherein the connector comprises an audio-visual input/output connector.

4. The wireless apparatus according to claim 1, wherein the encryption and the decryption units comprise 3DES (Triple Data Encryption Standard) technology developed by NIST (National Institute of Standards and Technology) in the US.

5. The wireless apparatus according to claim 1, which further comprises a RNG (Radio Network Gateway), a high voltage generator, a voltage frequency detector, a temperature detector, a light exposure detector, and a de-capsulation detector.

6. The wireless apparatus according to claim 1, wherein the identification hardware is a fingerprint scanner, an IC card chip, or both of above.

7. The wireless apparatus according to claim 1, wherein the wireless transceiver is a duplex transceiver or a simplex transceiver.

8. The wireless apparatus according to claim 1, wherein the audio-visual device is a MP3 (MPEG Audio Layer 3), a DVD (Digital Video Disc), a VCD (Video Compact Disc), or a CD (Compact Disc) player.

9. The wireless apparatus according to claim 1, wherein the audio-visual device is a loudspeaker or a headphone.
